(19) United States
(12) Patent Application Publication
(10) Pub. No.: US 2025/0030870 A1
(43) Pub. Date: Jan. 23, 2025

(54) MULTIPLE PREDICTION MODELS AND SIGNALING IN VIDEO CODING

(71) Applicant: QUALCOMM Incorporated, San Diego, CA (US)

(72) Inventors: Vadim Seregin, San Diego, CA (US); Marta Karczewicz, San Diego, CA (US)

(21) Appl. No.: 18/772,917

(22) Filed: Jul. 15, 2024

Related U.S. Application Data
(60) Provisional application No. 63/514,927, filed on Jul. 21, 2023.

(51) Int. Cl. H04N 19/149; H04N 19/105; H04N 19/176

(52) U.S. Cl. CPC H04N 19/149; H04N 19/105; H04N 19/176

(57) ABSTRACT

A method of encoding or decoding video data includes for each of a plurality of models, deriving respective model parameters associated with respective corresponding models of the plurality of models utilizing a first set of samples; determining a respective cost value associated with the corresponding models of the plurality of models utilizing the respective model parameters and a second set of samples to generate respective cost values for the plurality of models, wherein the first set of samples and the second set of samples are exclusive of one another; determining a model of the plurality of models to use for encoding or decoding a current block based on the respective cost values; and encoding or decoding the current block based on the determined model.

This application claims the benefit of U.S. Provisional Application No. 63/514,927, filed Jul. 21, 2023, the entire contents of which are hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for determining a model to use for generating a prediction (e.g., prediction block) for video coding. In video coding, a current block of video data is predicted from a prediction block, and there may be various ways in which to generate the prediction block, such as based on a model. This disclosure describes example techniques to determine (e.g., with minimal to no signaling) the model that is used for generating the prediction. For instance, a video encoder and a video decoder may determine cost values associated with each of the models, and determine a model to use based on the cost values. With the example techniques described in this disclosure, there may be a reduction in the amount of information that is signaled, and therefore, a reduction in bandwidth utilization.

For a current block that is to be encoded or being decoded, the video encoder and the video decoder may derive model parameters for each of the models utilizing a first set of samples. In one or more examples, the video encoder and the video decoder may utilize a second set of samples and the respective model parameters to determine a cost value associated with each of the models. For example, the video encoder and the video decoder may apply the model parameters to the second set of samples to generate prediction samples, and determine the cost value based on the difference between the prediction samples and the second set of samples. In one or more examples, the first set of samples and the second set of samples may be different. For instance, the first set of samples and the second set of samples may be exclusive of one another.

In one example, the disclosure describes a method of encoding or decoding video data, the method comprising: for each of a plurality of models, deriving respective model parameters associated with respective corresponding models of the plurality of models utilizing a first set of samples; determining a respective cost value associated with the corresponding models of the plurality of models utilizing the respective model parameters and a second set of samples to generate respective cost values for the plurality of models, wherein the first set of samples and the second set of samples are exclusive of one another; determining a model of the plurality of models to use for encoding or decoding a current block based on the respective cost values; and encoding or decoding the current block based on the determined model.

In one example, the disclosure describes a device for encoding or decoding video data, the device comprising: one or more memories configured to store the video data; and processing circuitry coupled to the one or more memories, wherein the processing circuitry is configured to: for each of a plurality of models, derive respective model parameters associated with respective corresponding models of the plurality of models utilizing a first set of samples; determine a respective cost value associated with the corresponding models of the plurality of models utilizing the respective model parameters and a second set of samples to generate respective cost values for the plurality of models, wherein the first set of samples and the second set of samples are exclusive of one another; determine a model of the plurality of models to use for encoding or decoding a current block based on the respective cost values; and encode or decode the current block based on the determined model.

In one example, the disclosure describes one or more computer-readable storage media storing instructions thereon that when executed cause one or more processors to: for each of a plurality of models, derive respective model parameters associated with respective corresponding models of the plurality of models utilizing a first set of samples; determine a respective cost value associated with the corresponding models of the plurality of models utilizing the respective model parameters and a second set of samples to generate respective cost values for the plurality of models, wherein the first set of samples and the second set of samples are exclusive of one another; determine a model of the plurality of models to use for encoding or decoding a current block based on the respective cost values; and encode or decode the current block based on the determined model.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a conceptual diagram illustrating an example of a spatial part of a convolutional filter.

FIG. 7 is a conceptual diagram illustrating an example of reference area with padding used to derive filter coefficients.

FIG. 8 is a conceptual diagram illustrating gradient and location based convolutional cross-component model (GL-CCCM).

FIG. 9 is a conceptual diagram illustrating luma samples in relation to a chroma sample.

FIG. 10 is a conceptual diagram illustrating locations in reconstructed samples.

FIGS. 11A and 11B are conceptual diagrams illustrating reference area for block vector guided CCCM (BVG-CCCM).

FIG. 12 is a conceptual diagram illustrating samples used for model validation.

FIG. 13 is a flowchart illustrating an example method in accordance with one or more examples described in this disclosure.

### DETAILED DESCRIPTION

In video coding, a video encoder and a video decoder determine a prediction (e.g., a prediction block) that is used to inter-predict or intra-predict a current block. For instance, the video encoder and the video decoder perform the same techniques to generate a prediction block based on previously encoded or decoded samples. The video encoder determines residual values indicative of a difference between the current block and the prediction block, and signals information indicative of the residual values. The video decoder receives the information indicative of the residual values, and adds the residual values to the prediction block to reconstruct the current block.

There may be various ways in which the video encoder and the video decoder may generate a prediction block. For instance, a current block may include a luma component (e.g., luma current block) and a chroma component (e.g., chroma current block). It may be possible to leverage the luma current block to generate a prediction block for the chroma current block. Moreover, it may be possible for video encoder and the video decoder to first determine a reference block, and then modify (e.g., filter, adjust, etc.) the reference block to generate the prediction block.

Various video coding techniques may define the ways in which to generate the prediction block, such as video coding techniques in High Efficiency Video Coding (HEVC) standard, Versatile Video Coding (VVC) standard, Enhanced Compression Model (ECM), AV1, and AV2. This disclosure is related to prediction in video codecs, in some examples it may be applicable to HEVC, VVC, ECM, AV1, AV2 and similar video codecs.

The various ways in which to generate the prediction block may be referred to as models. In ECM, there are multiple tools that utilize model derivation at the video encoder and the video decoder to form a prediction. The examples of such tools are local intensity compensation (LIC), linear model (LM), convolutional cross-component model (CCCM), where the model is derived by using reconstructed neighbor luma and chroma samples to derive cross-component model or using neighbor samples and neighbor samples of a reference block to derive the model for inter-prediction (e.g., prediction based on samples in a picture other than the picture that includes the current block).

In general, a “model,” as used in this disclosure, refers to an encoding or decoding technique in which a video encoder and a video decoder apply model parameters (e.g., scale and offset) to sample values to generate a prediction block for the current block being encoded or decoded. The sample values may be for previously reconstructed samples, and the model parameters may be applied as part of the pixel domain (e.g., before transform or quantization from video encoder perspective and after inverse-quantization and inverse-transform from video decoder perspective). The video encoder and the video decoder may determine the model parameters based on previously reconstructed samples. In some examples, the video encoder may signal, and the video decoder may receive the model parameters.

In model-based video coding, there may be three operations to determine a prediction block (e.g., prediction signal) for a current block. The first operation may be to determine the model parameters. The second operation may be to determine samples on which to apply the model parameters. The third operation may be to apply the model parameters (e.g., perform scaling and/or offsetting using the model parameters) to the determined samples to generate the prediction block. The samples on which to apply the model parameters may be previously reconstructed samples. For instance, for cross-component model-based video coding, the current block may be a chroma block, and the previously reconstructed samples may be based on downsampled, if needed, luma samples of a luma block.

As noted, there can be multiple models. This disclosure describes example techniques to reduce the amount of signaling needed to indicate the model to use. For example, some ways to indicate a model is to signal syntax element(s) in a bitstream. That is, the video encoder signals syntax elements that indicate the model to be used, and the video decoder receives the syntax elements and determines the model to be used based on the syntax element. However, as a number of models may be relatively large, the signaling overhead of syntax element may increase.

In one or more examples, a video encoder and a video decoder may determine respective cost values associate with a corresponding model of a plurality of models, determine a model to use for coding a current block based on the respective cost values, and code the current block based on the determined model. There may be various example ways to determine the cost values such as based on target samples (e.g., neighboring samples) of the current block.

For example, as described above, in model-based video coding, the video encoder and the video decoder may each determine model parameters. In one or more examples, the video encoder and the video decoder may derive respective model parameters associated with respective corresponding models of the plurality of models utilizing a first set of samples. For instance, the video encoder and the video decoder may determine first model parameters for a first model based on a first set of samples, determine second model parameters for a second model based on a first set of samples, and so forth. The first set of samples used to determine model parameters need not necessarily be the same for each of the models, as different models may use different samples for model parameter derivation. However, it is possible for the first set of samples to be the same for each of the models.

The video encoder and the video decoder may determine a respective cost value associated with the corresponding models of the plurality of models utilizing the respective model parameters and a second set of samples to generate respective cost values for the plurality of models. The first set of samples and the second set of samples may be exclusive of one another in some examples, may partially overlap in some examples, or may be the same in some examples.

As an example, the video encoder and the video decoder may generate prediction samples for the second set of samples based on the model parameters (e.g., the model parameters that were derived using the first set of samples). For example, the video encoder and the video decoder may determine first prediction samples for the first model based on the first model parameters for the first model but the first prediction samples are determined for the second set of samples, determine second prediction samples for the second model based on the second model parameters for the second model but the second prediction samples are determined for the second set of samples, and so forth.

Since the first set of samples and the second set of samples were already reconstructed, the generated prediction samples for the second set of samples are used for purposes of model selection. For example, although the second set of samples are already fully reconstructed, the video encoder and the video decoder may perform the operations to encode or decode the second set of samples, such as, generate prediction samples for the second set of samples. However, the second set of samples are already known, and therefore, the encoding and decoding process is for model selection. Moreover, these generated prediction samples for the second set of samples may not be the prediction samples used for encoding or decoding the current block.

The video encoder and the video decoder may determine a difference between the generated prediction samples and the second set of samples to determine the respective cost values. For example, the video encoder and the video decoder may determine a first cost value based on a sum of absolute differences (SAD) between the second set of samples and the first prediction samples for the first model, determine a second cost value based on the SAD between the second set of samples and the second prediction samples for the second model, and so forth.

The video encoder and the video decoder may determine a model of the plurality of models to use for encoding or decoding a current block based on the respective cost values. The video encoder and the video decoder may encode or decode the current block based on the determined model. That is, the above example techniques may assist in model selection, but once the model is selected, the video encoder and the video decoder may perform operations consistent with that determined model to generate a prediction block that is used to encode or decode the current block.

For instance, the video encoder and the video decoder may encode or decode the current block in either of an inter-prediction mode or an intra-prediction mode. For example, after the model that is used for coding the current block is determined using the above example techniques, the video encoder and the video decoder may perform the operations to generate a prediction block for the current block using the determined model. If the determined model requires the video encoder and the video decoder to access samples from another picture than the picture that includes the current block (e.g., inter-prediction) to generate the prediction block for the current block, the video encoder and the video decoder may perform such operations consistent with the determined model. If the determined model requires the video encoder and the video decoder to access samples from the same picture as the picture that includes the current block (e.g., intra-prediction or intra-block copy prediction) to generate the prediction block for the current block, the video encoder and the video decoder may perform such operations consistent with the determined model.

With the example techniques, it may be possible to reduce the signaling overhead. For instance, in some examples, the video encoder and the video decoder may utilize model having the least cost, in which case the video encoder may not need to signal syntax elements that define the model. As another example, the video encoder and the video decoder may each construct a model list of candidates based on the respective cost values (e.g., order the model list in ascending order based on cost values). That is, the video encoder and the video decoder may construct a model list of candidates, where the candidates are ordered in the model list based on the respective cost values. The video encoder may signal an index into the model list, which may require less signaling overhead, as compared to signaling the syntax element. As another example, the video encoder and the video decoder may associate at least one of the model with the current block or an index into a model list of candidates that identifies the model and store information indicative of the association. The video encoder and the video decoder may code a subsequent block based on the information indicative of the association, which may reduce the amount of signaling for coding the subsequent block.

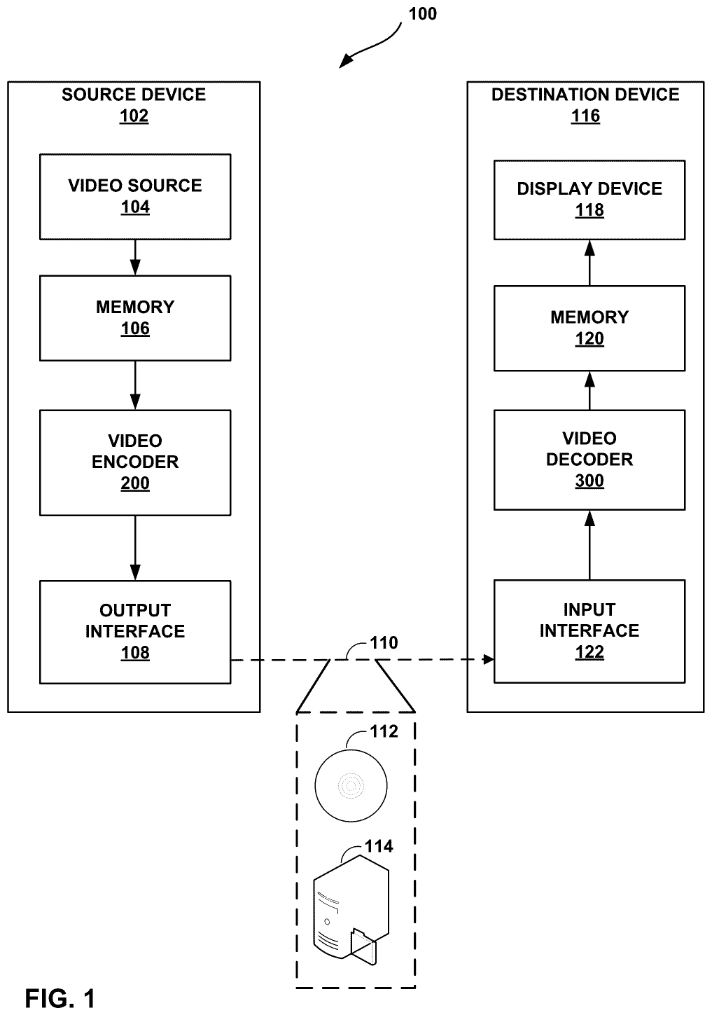

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for using multiple prediction models and signaling in video coding. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for using multiple prediction models and signaling in video coding. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use multiple prediction models and signaling in video coding.

For instance, video encoder 200 and video decoder 300 may utilize various models for generating a prediction (e.g., prediction block). This disclosure describes example techniques to determine which model to use while reducing signaling overhead. In this manner, video encoder 200 and video decoder 300 can support an increase in the number of models that can be used while minimizing signaling overhead penalties with the increase of models.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, there are multiple tools that utilize model derivation at video encoder 200 and video decoder 300 to form a prediction. The examples of such tools are local intensity compensation (LIC), linear model (LM), convolutional cross-component model (CCCM), where the model is derived by using reconstructed neighbor luma and chroma data to derive cross-component model or using neighbor samples and neighbor samples of a reference block to derive the model for inter prediction.

As described above, a “model,” as used in this disclosure, refers to an encoding or decoding technique in which video encoder 200 and video decoder 300 apply model parameters (e.g., scale and offset) to sample values to generate a prediction block for the current block being encoded or decoded. The sample values may be for previously reconstructed samples, and the model parameters may be applied as part of the pixel domain (e.g., before transform or quantization from video encoder perspective and after inverse-quantization and inverse-transform from video decoder perspective). The video encoder and the video decoder may determine the model parameters based on previously reconstructed samples. In some examples, the video encoder may signal, and the video decoder may receive the model parameters. For example, for model-based coding, video encoder 200 and video decoder 300 may determine model parameters based on previously reconstructed samples, determine samples on which to apply the model parameters, which may be based on previously reconstructed samples, and apply the model parameters (e.g., perform scaling and/or offsetting using the model parameters) to the determined samples to generate the prediction block for the current block.

As described in more detail, the example techniques relate to video encoder 200 and video decoder 300 determining the same model to use for encoding or decoding a current block in manner that reduces signaling overhead. For instance, the example techniques may reduce signaling overhead for selecting a model from a plurality of existing models. Moreover, as additional models become available, inclusion of such models for video coding may be possible without much increased signaling overhead. Furthermore, the example techniques may be applicable to the current block being encoded or decoded using inter-prediction or intra-prediction.

One way to indicate a model is to signal syntax element in a bitstream. However, when number of models is large then signaling the overhead may be relatively high. As noted above, this disclosure describes examples of determining which model to use while reducing signaling overhead.

The following describes some examples of models used in video coding. The example techniques should not be considered limited to the example models.

For convolutional cross-component model (CCCM), in JVET-Z0064 (Lainema et al., “AHG12: Convolutional cross-component model (CCCM) for intra prediction” Joint Video Experts Team (JVET) of ITU-T SG 16 WP 3 and ISO/IEC JTC 1/SC 29, 26^{th} meeting, by teleconference, 20-29 Apr. 2022) and JVET-AA0057 (Astola et al., “EE2-1.1a: Convolutional cross-component intra prediction model” Joint Video Experts Team (JVET) of ITU-T SG 16 WP 3 and ISO/IEC JTC 1/SC 29, 27^{th} meeting, by teleconference, 13-22 Jul. 2022), it is proposed to apply convolutional cross-component model (CCCM) to predict chroma samples from reconstructed luma samples in similar techniques as done by the cross-component linear model (CCLM) modes. As with CCLM, the reconstructed luma samples are down-sampled to match the lower resolution chroma grid when chroma sub-sampling is used.

Also, similar to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

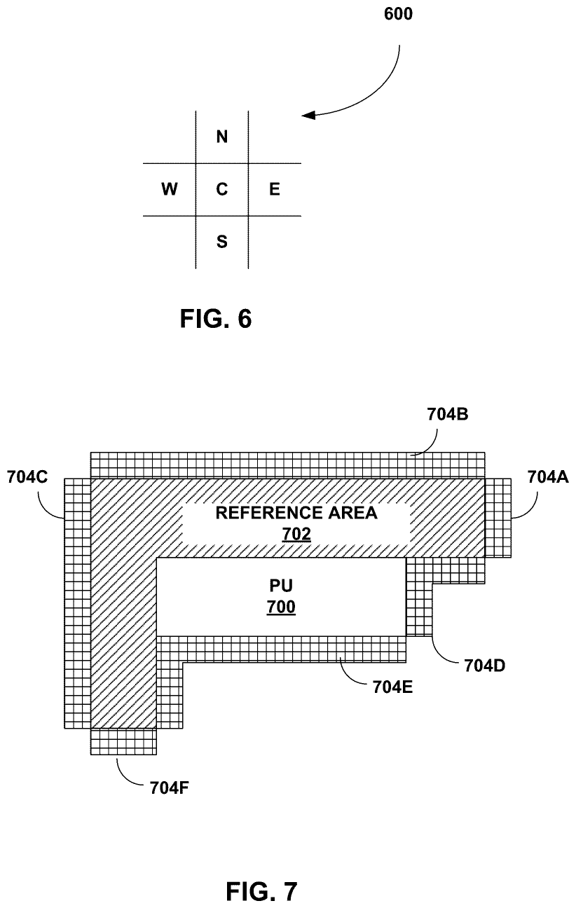

The convolutional 7-tap filter that is used consists of a 5-tap plus sign shape spatial component, a nonlinear term and a bias term. The input to the spatial 5-tap component of the filter 600 consists of a center (C) luma sample which is collocated with the chroma sample to be predicted and the above/north (N), below/south (S), left/west (W) and right/east (E) neighbors of the chroma sample to be predicted, as illustrated in FIG. 6.

If the color format is not 4:4:4, where chroma has fewer number of samples than luma, the luma samples described above are down sampled luma samples. The nonlinear term P is represented as power of two of the center luma sample C and scaled to the sample value range of the content: P=(C*C+midVal)>>bitdepth. That is, for 10-bit content it is calculated as: P=(C*C+512)>>10.

The bias term B represents a scalar offset between the input and output (similarly to the offset term in CCLM) and is set to middle chroma value (512 for 10-bit content). Output of the filter is calculated as a convolution between the filter coefficients cᵢ and the input values and clipped to the range of valid chroma samples: predChromaVal=c₀C+c₁N+c₂S+c₃E+c₄W+c₅P+c₆B.

The filter coefficients cᵢ are calculated by minimising MSE (mean squared error) between predicted and reconstructed chroma samples in the reference area. FIG. 7 illustrates the reference area 702 which consists of 6 lines of chroma samples above and left of the PU 700. Reference area 702 extends one PU width to the right and one PU height below the PU boundaries. The area may be adjusted to include only available samples. The extensions to the area shown as reference numerals 704A-704F may be needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF (adaptive loop filtering) filter coefficients in ECM, however LDL decomposition was chosen instead of Cholesky decomposition to avoid using square root operations. The above example approach uses only integer arithmetic for the model.

In JVET-AB0180 (Jhu et al., “Non-EE2: CCCM using non-downsampled luma samples” Joint Video Experts Team (JVET) of ITU-T SG 16 WP 3 and ISO/IEC JTC 1/SC 29, 28^{th} meeting, Mainz, DE, 20-28 Oct. 2022) and JVET-AB0187 (Seregin et al., “Non-EE2: No luma subsampling for CCCM” Joint Video Experts Team (JVET) of ITU-T SG 16 WP 3 and ISO/IEC JTC 1/SC 29, 28^{th} meeting, Mainz, DE, 20-28 Oct. 2022), CCCM using non-downsampled luma samples and no luma subsampling for CCCM were proposed to predict the chroma samples from the reconstructed luma samples (i.e., without downsampling). In the case of typical 4:2:0 color format, it (e.g., the example techniques of JVET-AB0187) consists of 6-tap spatial terms, four nonlinear terms, and a bias term. The 6-tap spatial terms correspond to 6 neighboring luma samples (i.e., L₀, L₁, . . . , L₅) around the chroma sample (i.e., C) to be predicted, the four non-linear terms are derived from the samples L₀, L₁, L₂, and L₃.

The equation for C is as follows: C=Σᵢ₌₀⁵αᵢ·(Lᵢ−offsetLuma)+Σᵢ₌₆⁹αᵢ·(((Lᵢ₋₄−offsetLuma)²+β)>>bitDepth)+α₁₀·β+offsetChroma, where αᵢ is the coefficient, β is the offset. If the coordinate of chroma sample is (x, y), the coordinate for Lᵢ (i=0, 1, . . . , 5) are (2x−1, 2y), (2x, 2y), (2x+1, 2y), (2x−1, 2y+1), (2x, 2y+1), (2x+1, 2y+1), respectively.

The following describes gradient and location based CCCM (GL-CCCM). GL-CCCM method uses gradient and location information instead of the 4 spatial neighbor samples in the CCCM filter. The GL-CCCM filter for the prediction is: predChromaVal=c₀C+c₁G_{y}+c₂Gₓ+c₃Y+c₄X+c₅P+c₆B, where G_{y} and Gₓ are the vertical and horizontal gradients, respectively, and are calculated as:

$${G}_{y} = ( 2 N + NW + NE ) - ( 2 S + SW + SE ) \\ {G}_{x} = ( 2 W + NW + SW ) - ( 2 E + NE + SE )$$

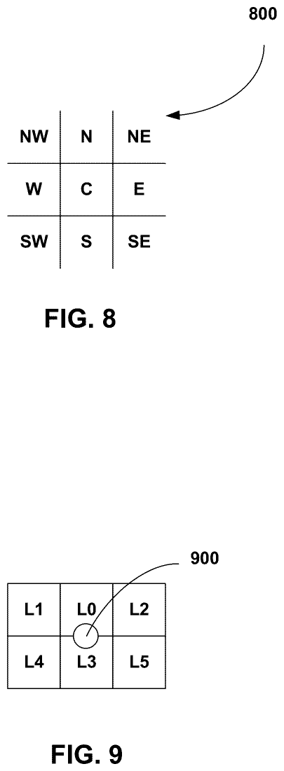

Moreover, the Y and X parameters are the vertical and horizontal locations of the center luma sample. The rest of the parameters are the same as CCCM tool. The reference area for the parameter calculation is the same as CCCM method. FIG. 8 is a conceptual diagram illustrating GL-CCCM filter 800.

The following describes cross-component residual model for inter-prediction. In JVET-AD0108 (Huang et al., “Non-EE2: Affine AMVP mode with one MVD” Joint Video Experts Team (JVET) of ITU-T SG 16 WP 3 and ISO/IEC JTC 1/SC 29, 30^{th} meeting, Antalya, TR, 21-28 Apr. 2023), it is proposed to apply cross-component residual model (CCRM) to predict chroma samples from reconstructed luma samples when the block uses inter prediction or intra block copy (IBC). The cross-component filters are derived using the prediction signals of luma and chroma. The derived filters are applied to the reconstructed luma signal producing the final chroma predictions.

The proposed 8-tap filter consist of 6 spatial luma samples, a nonlinear term, and a bias term. The spatial luma samples (L0, . . . , L5) are obtained from the luma grid selecting the 6 luma samples closest to the chroma position C without down sampling as shown in FIG. 9. The predicted chroma value is obtained as: predChromaVal=c₀L0+c₁L1+c₂L2+c₃L3+c₄L4+c₅L5+c₆ nonlinear((L0+L3+1)>>1)+c₇ B, where nonlinear is CCCM's nonlinear operator and B is bias.

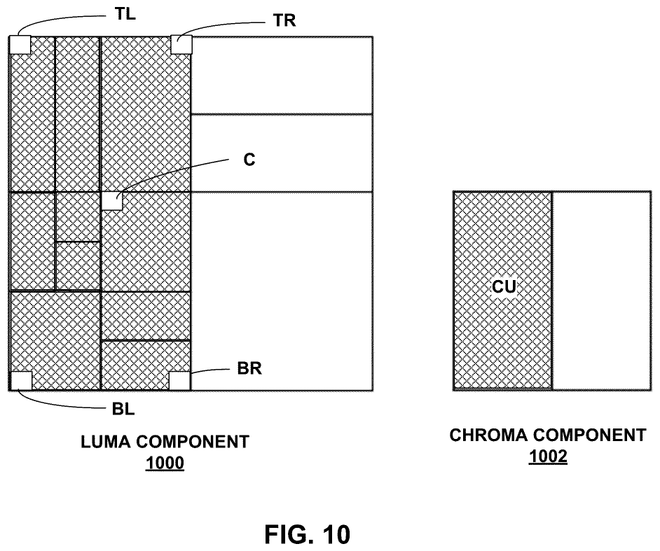

The following describes direct block vector mode for chroma prediction. In JVET-AC0071 (Huo et al., “EE2-3.1: Direct block vector mode for chroma prediction” Joint Video Experts Team (JVET) of ITU-T SG 16 WP 3 and ISO/IEC JTC 1/SC 29, 29^{th} meeting, by teleconference, 11-20 Jan. 2023), direct block vector is proposed to improve the coding efficiency for chroma components when dual tree is activated in intra slice. The methods in JVET-AC0071 include two implementations. When chroma dual tree is activated in intra slice, for a chroma CU coded as DBV mode, if one of the luma blocks in five locations, as shown in FIG. 10 for luma component 1000, the five location in reconstructed luma samples, is coded with IBC mode or IntraTmp mode, its block vector bvL is used to derive chroma block vector bvC. FIG. 10 also illustrates chroma component 1002.

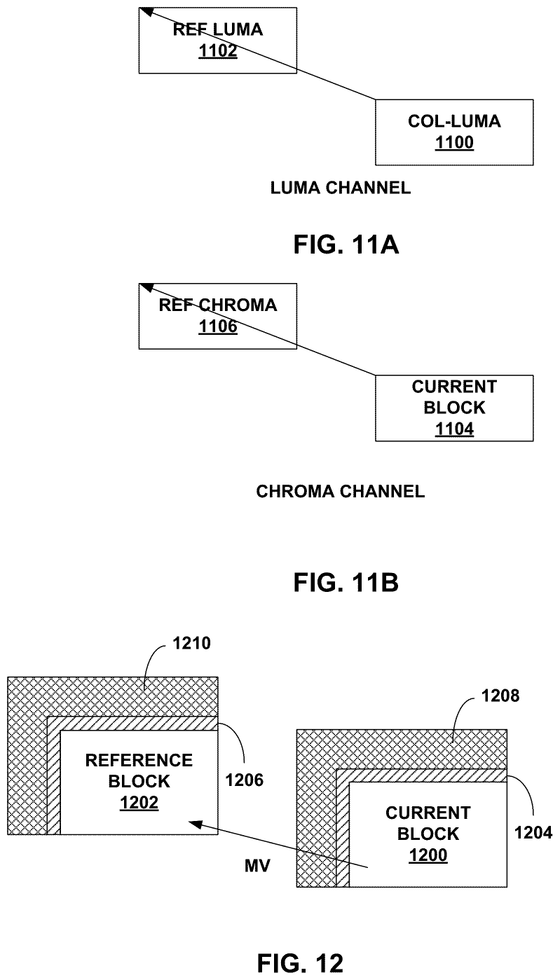

The following describes block vector guided CCCM. In JVET-AD0100 (Youvalari et al., “AHG12: Block vector guided CCCM” Joint Video Experts Team (JVET) of ITU-T SG 16 WP 3 and ISO/IEC JTC 1/SC 29, 30^{th} meeting, Antalya, TR, 21-28 Apr. 2023), block vector guided CCCM (BVG-CCCM) method is proposed for improving the coding efficiency of ECM. The BVG-CCCM method uses block vector of the co-located luma block, coded in IBC or intraTMP mode, to determine the reference area for calculating the CCCM parameters. Then the reference area in luma and corresponding area in chroma channel is used to calculate the CCCM parameters. The prediction uses the calculated model parameters and co-located luma samples to do the CCCM prediction. FIGS. 11A and 11B illustrate reference area for BVG-CCCM method. For instance, FIG. 11A illustrates ref luma 1102 for col-luma 1100, and FIG. 11B illustrates ref chroma 1106 for current block 1104.

Similar to Direct Block Vector (DBV) mode in ECM-8.0, five locations in collocated luma block area are scanned for determining the block vector to be used in BVG-CCCM method. Usage of the mode is signalled with a CABAC coded PU level flag. The BVG-CCCM flag is signalled if co-located block is coded in IBC or intraTMP modes and the cross-component index is LM_CHROMA_IDX or MMLM_CHROMA_IDX.

The following describes cross-component merge mode for chroma intra coding. In JVET-AC0315 (Tsai et al., “Non-EE2: Cross-component merge mode for chroma intra coding” Joint Video Experts Team (JVET) of ITU-T SG 16 WP 3 and ISO/IEC JTC 1/SC 29, 29^{th} meeting, by teleconference, 11-20 Jan. 2023), a cross-component merge (CCMerge) mode for chroma intra coding is introduced, comprising of cross-component model parameters inheritance for the current chroma block from its spatial adjacent and non-adjacent neighbors, or default models. The spatial adjacent and non-adjacent neighboring information is collected from the previously blocks coded by CCLM, MMLM, CCCM, GLM, chroma fusion, and CCMerge modes. The final cross-component model parameters of the current chroma block can be inherited from its spatial adjacent and non-adjacent neighbors, or default models. A list is created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations are applied.

The following describes dynamic range reduction for convolutional cross-component model. JVET-AA0114 (Aminlou et al., “EE2-related: Division-free operation and mean-compensation for convolutional cross-component model (CCCM)” Joint Video Experts Team (JVET) of ITU-T SG 16 WP 3 and ISO/IEC JTC 1/SC 29, 27^{th} meeting, by teleconference, 13-22 Jul. 2022) proposed to simplify the implementation of CCCM by removing mean of reference samples from sample values and replacing division operation by a piece-wise polynomial function. The division removal was noted desirable, but mean removal was considered undesirable as it introduces an additional pipeline stage. In JVET-AB0174 (Aminlou et al., “AHG12: Division-free operation and dynamic range reduction for convolutional cross-component model (CCCM)” Joint Video Experts Team (JVET) of ITU-T SG 16 WP 3 and ISO/IEC JTC 1/SC 29, 28^{th} meeting, Mainz, DE, 20-28 Oct. 2022), mean removal is replaced by offset removal which does not add any additional pipeline stage nor additional sample level operations. JVET-AB0174 proposed to remove fixed offsets from luma and chroma samples in each PU for each model, which may result in driving down the magnitudes of the values used in the model creation and allows reducing the precision needed for the fixed-point arithmetic. As a result, 16-bit decimal precision is proposed in JVET-AB0174 to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma \\ {N}^{′} = N - offsetLuma \\ {S}^{′} = S - offsetLuma \\ {E}^{′} = E - offsetLuma \\ {W}^{′} = W - offsetLuma \\ {P}^{′} = n o n L i n e a r ( {C}^{′} ) \\ B = midValue = 1 << ( bitDepth - 1 )$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} {B}^{′} + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model. With this selection the convolution operation also takes exactly the same amount of operations as the original implementation of CCCM.

As illustrated by the examples above, there can be multiple models. As described above, a “model” may refer to video coding techniques in which model parameters (e.g., scale or offset parameters) are determined based on previously reconstructed samples, and the model parameters are applied to samples determined from the pixel domain to generate a prediction block for a current block. Techniques to determine the model parameters, techniques to determine the samples on which the model parameters are applied, and/or techniques to apply the model parameters to samples may be different for the different models.

Accordingly, in some techniques, video encoder 200 would signal information to video decoder 300 indicating the model to use for coding the current block. One way to indicate a model is to signal syntax element in a bitstream. However, when number of models is large then signaling the overhead may be relatively large. The following describes examples that may address the issues of signaling overhead with the inclusion of various models. The following example techniques may be performed independently or in any combination.

In some examples, video encoder 200 and video decoder 300 may use a cost function to produce a cost measure (i.e., cost value) for each model, and order those multiple models using that cost value. Then, in one example, video encoder 200 may signal an index to the ordered candidate model list, or video encoder 200 and video decoder 300 may select the smallest cost model.

To derive the cost, the derived model is applied to the samples used to derive the model, the difference between the samples after model application and the neighbor samples of the current block may indicate the model error, and this error may be used as a cost measure. In another example, the derived model is applied to the samples not used in the model derivation, then the difference between the target samples and the samples derived after the model derivation may be used as cost measure, for example the sum of absolute differences, optionally normalized by the number of samples involved in the cost derivation.

Stated another way, assume that a current block is to be encoded or decoded. For each of a plurality of models, video encoder 200 and video decoder 300 may derive respective model parameters associated with respective corresponding models of the plurality of models utilizing a first set of samples. The first set of samples may include samples that are not immediately adjacent to the current block, or may include samples that are not immediately adjacent to the current block and samples that are not immediately adjacent to a reference block. From the perspective of video encoder 200, the first set of samples may be previously encoded samples that have been reconstructed through a decoder loop (e.g., reconstruction loop) of video encoder 200. From the perspective of video decoder 300, the first set of samples may be previously decoded samples. That is, both video encoder 200 and video decoder 300 have the values for the first set of samples. The first set of samples may be chroma samples, luma samples, or both chroma samples and luma samples.

For instance, the plurality of models may include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge). In some examples, at least one of the plurality of models is a model used to encode or decode a temporally or spatially neighboring block of the current block.

Each of these models may define a particular manner in which to derive respective model parameters. Video encoder 200 and video decoder 300 may input the first set of samples to derive model parameters in the defined manner for each of the models. For instance, video encoder 200 and video decoder 300 may input the first set of samples to determine model parameters for LIC, input the first set of samples to determine model parameters for LM, and so forth.

It should be noted that the first set of samples need not be identical for deriving model parameters for each of the models. For instance, one model may require one set of samples to determine model parameters, and another model may require another set of samples. Accordingly, in this disclosure, for each of a plurality of models, deriving respective model parameters associated with respective corresponding models of the plurality of models utilizing a first set of samples may mean for each of a plurality of models, deriving respective model parameters associated with respective corresponding models of the plurality of models utilizing the samples that are used to derive model parameters for that particular model. However, it may be possible for the first set of samples to be the same for each model as well.

Video encoder 200 and video decoder 300 may determine a respective cost value associated with the corresponding models of the plurality of models utilizing the respective model parameters and a second set of samples to generate respective cost values for the plurality of models. In some examples, the first set of samples and the second set of samples may be the same set of samples or may partially overlap.

In some examples, the first set of samples and the second set of samples are exclusive of one another. That is, none of the first set of samples are included in the second set of samples, and vice-versa. Similar to above, it should be noted that the second set of samples need not be identical for each of the models. However, it may be possible for the second set of samples to be the same for each model as well.

For example, where the first set of samples and the second set of samples are exclusive of one another, the second set of samples may include samples immediately adjacent to the current block, and the first set of samples may include samples that are not immediately adjacent to the current block. As another example, where the first set of samples and the second set of samples are exclusive of one another, the second set of samples include samples immediately adjacent to the current block and samples immediately adjacent to a reference block, and the first set of samples include samples that are not immediately adjacent to the current block and samples that are not immediately adjacent to the reference block.

To determine the respective cost values, video encoder 200 and video decoder 300 may, for each of the plurality of models, generate prediction samples for the second set of samples based on the model parameters. That is, video encoder 200 and video decoder 300 may perform operations on the second set of samples as if the second set of samples were being predicted. As described above, as part of model-based coding, video encoder 200 and video decoder 300 generate prediction samples for a block being encoded or decoded. In one or more examples, video encoder 200 and video decoder 300 may utilize the second set of samples as a block or blocks that are to be encoded or decoded. Again, the second set of samples have already been encoded or decoded, but for purposes of model selection (e.g., determining a model to use for encoding or decoding a current block), video encoder 200 and video decoder 300 may determine the prediction samples for the second set of samples consistent with the techniques for each of the models.

Since the second set of samples are already known, video encoder 200 and video decoder 300 may determine a difference between the prediction samples and the second set of samples (e.g., such as SAD or some other technique). Video encoder 200 and video decoder 300 may determine the cost value associated with the model based on the determined difference. As one example, video encode 200 and video decoder 300 may determine the SAD value of each of the models as the cost value.

For example, to determine the respective cost values, video encoder 200 and video decoder 300 may determine a first prediction signal associated with a first model of the plurality of models based on model parameters of the first model, and determine a first cost value of the respective cost values based on a difference between the first prediction signal and the second set of samples. Video encoder 200 and video decoder 300 may determine a second prediction signal associated with a second model of the plurality of models based on model parameters of the second model, and determine a second cost value of the respective cost values based on a difference between the second prediction signal and the second set of samples, and so forth.

In some examples, to determine the model, video encoder 200 and video decoder 300 may select the model associated with a lowest cost value of the respective cost values. In some examples, video encoder 200 and video decoder 300 may construct a model list of candidates based on the respective cost values (e.g., ordered from least cost to most cost). That is, video encoder 200 and video decoder 300 may construct a model list of candidates, where the candidates are ordered in the model list based on the respective cost values. To determine the model, video encoder 200 and video decoder 300 may select the model from the model list of candidates. Video encoder 200 may signal and video decoder 300 may parse an index into the model list of candidates.

As an example, using LIC tool for purposes of illustration, typical LIC model is a linear model used to compensate a local illumination change that can be formulated as pred=a*sample+b, where pred is the final predictor, sample is the sample after motion compensation, a and b are linear model parameters derived from reconstructed neighbor samples of the current block and the neighbor sample of the reference block indicated by a motion vector. Linear least square minimization process may be used to derive the model parameters.

In the LIC extensions, there may be several LIC models, such as using only left side template, only above template in addition to using left and above templates together. In other examples, additional LIC model may have different spatial template such as 3×3 cross shape, 3×3 diamond and others. It may also include various non-linear terms and biases.

Those multiple model are derived from the reconstructed neighbor samples of the current and reference blocks, and similar linear least minimization process may be used. Then those models may be applied to the reconstructed neighbor reference samples and the difference is derived using the samples after model application and the reconstructed neighbor samples of the current block. That sum of the absolute difference may be used as a cost measure.

In some examples, some neighbor samples of the current block and the reference block may be reserved and are not used in model derivation, but such samples are used for model validation to produce the cost measure as shown in FIG. 12. For example, FIG. 12 illustrates current block 1200 and reference block 1202. Samples 1204 and 1206 may be used to validate the model, and samples 1208 and 1210 may be used to derive the model.

In FIG. 12, the neighbor samples 1208 of the current block 1200 and neighbor samples 1210 of reference block 1202 are used to derive the model, while the reserved samples (e.g., samples 1204 and 1206), which were not used in model derivation, are used to validate the model and to derive the cost. To derive the cost, in one example, the model is applied to samples 1206 of the reference block 1202 and the difference is calculated between the samples after the model application and samples 1204 of the current block 1200. Then the sum of absolute differences, optionally normalized by the number of the involved samples, may be used as a cost measure.

The above provides some examples of samples used for deriving the model and or validating. However, other line or lines, other than or in addition to the above examples, not necessarily the closet to the block, may be reserved and used for model derivation.

For example, for each of a plurality of models, video encoder 200 and video decoder 300 may derive respective model parameters associated with respective corresponding models of the plurality of models utilizing a first set of samples 1208 and/or 1210. For instance, the first set of samples may include samples that are not immediately adjacent to current block 1200, such as samples 1208. The first set of samples may include samples that are not immediately adjacent to the current block 1200, such as samples 1208, and samples that are not immediately adjacent to the reference block 1202, such as samples 1210. Again, which samples within samples 1208 or 1210 are utilized may be based on the specific model parameter (e.g., scale and offset parameters) derivation techniques.

The model parameters may be nonlinear term P and the bias term B for CCLM. The model parameters may be non-linear terms derived from samples L₀ to L₃ and the offset β for CCCM using non-downsampled luma samples. The vertical and horizontal gradients along with the nonlinear term P and the bias term B may be examples of model parameters for GL-CCCM. The above are a few examples of model parameters, and there may be similar to other model parameters for different models.

Video encoder 200 and video decoder 300 may determine a respective cost value associated with the corresponding models of the plurality of models utilizing the respective model parameters and a second set of samples to generate respective cost values for the plurality of models. In some examples, the first set of samples and the second set of samples are exclusive of one another. For instance, the second set of samples may be samples 1204 and/or samples 1206. The second set of samples may include samples immediately adjacent to the current block 1200, such as samples 1204. The second set of samples may include samples immediately adjacent to the current block 1200, such as samples 1204, and samples immediately adjacent to a reference block 1202, such as samples 1206.

There may be various ways in which to determine the respective cost values. As one example, for each of the plurality of models, video encoder 200 and video decoder 300 may generate prediction samples for the second set of samples based on the model parameters. As noted above, video encoder 200 and video decoder 300 may perform the operations to encode or decode the second set of samples, such as generate prediction samples for the second set of samples. However, the second set of samples are already known, and therefore, the encoding and decoding process is for model selection. Video encoder 200 and video decoder 300 may determine a difference between the prediction samples and the second set of samples, and determine the cost value associated with the model based on the determined difference.

For instance, video encoder 200 and video decoder 300 may determine a first prediction signal associated with a first model of the plurality of models based on model parameters of the first model, and determine a first cost value of the respective cost values based on a difference between the first prediction signal and the second set of samples. Video encoder 200 and video decoder 300 may determine a second prediction signal associated with a second model of the plurality of models based on model parameters of the second model, and determine a second cost value of the respective cost values based on a difference between the second prediction signal and the second set of samples. Video encoder 200 and video decoder 300 may repeat these operations to determine respective cost values for all of the plurality of models.

Video encoder 200 and video decoder 300 may determine a model of the plurality of models to use for encoding or decoding a current block 1200 based on the respective cost values. As one example, video encoder 200 and video decoder 300 may select the model associated with a lowest cost value of the respective cost values to determine the model. As another example, video encoder 200 and video decoder 300 may construct a model list of candidates based on the respective cost values (e.g., order the models based on cost from lowest cost to highest cost). That is, video encoder 200 and video decoder 300 may construct a model list of candidates, where the candidates are ordered in the model list based on the respective cost values. To determine the model, video encoder 200 and video decoder 300 may select the model from the model list of candidates. For example, video encoder 200 may signal and video decoder 300 may parse information indicative of an index into the model list of candidates. Generally, signaling smaller values requires fewer signaling bits, and ordering the models from lowest cost (e.g., higher likelihood of use) to highest cost (e.g., lower likelihood of use) may mean that video encoder 200 is likely to signal a relatively small valued index, which increase the likelihood of reducing the amount of signaling bits.

Video encoder 200 and video decoder 300 may encode or decode the current block 1200 based on the determined model. As one example, video encoder 200 and video decoder 300 may encode or decode the current block 1200 in either of an inter-prediction mode or an intra-prediction mode. In general, once video encoder 200 and video decoder 300 determine the model to use for encoding or decoding the current block 1200, video encoder 200 and video decoder 300 may perform operations in accordance with the usage of the determined model. For example, video encoder 200 and video decoder 300 may determine model parameters in accordance with the determined model, and apply those model parameters to samples to generate prediction samples (e.g., a prediction block) for the current block 1200.

As mentioned in the above examples, there may be multiple models used for prediction. In video coding, there are typical two types for prediction schemes, where model selection is signaled and where the model may be inherited from the neighbor blocks. In inter-prediction, an example of the first approach is AMVP (advanced motion vector prediction) mode, and an example for the second approach is merge mode.

In case of using multiple models, an index may be signaled to the list of model candidates to indicate the selected model. To reduce the overhead, only one or less than the total number of models in the initial list may be signaled after the list is reordered based on the cost measure of each models, e.g. in ascending order of the cost, in other words only one or several best models may be used.

Then the selected model index is stored with the block, or an index to the total list may be stored. Since different blocks may have different cost for the same models and the different models may have the same index after optional list reordering and reduction in size as mentioned earlier, so keeping the index to the total list may be beneficial since it may uniquely identify the model. This signaling, in one example, may be applied to AMVP mode.

When model is inherited from neighboring blocks (spatially adjacent or non-adjacent) or temporally collocated blocks, such as in merge mode, the stored index of the model is also inherited to indicate the model. Other types of neighboring blocks should be considered as part of this description, as a block from where a model is inherited should not be considered as limiting the example techniques.

If candidate list pruning is applied, typically the same or similar motion candidates are removed from the list, the model information may be ignored in the pruning or being considered. If considered, then the model cost may be compared during the pruning model and the candidate having a model with the smaller cost may be retained in the candidate list.

Several models may be combined to form a prediction. In some examples, several models from the model list may be selected and a weighted combination may be performed. In one example, the models with the smallest costs may be selected for a combination. The number of the selected models from the model list may be predefined or may be adaptive. In one adaptive example, a threshold for the costs may be used, and models with the costs smaller than the threshold may be used.

A weighted factor may be fixed, for example, equal weights of 1/N, where N is the number of models. Alternatively or additionally, weights may be signaled using high level signaling, in some examples, SPS, PPS, picture or slice header, as well as at a block level.

In some examples, the weights may be derived by video encoder 200 and video decoder 300. In one example, the cost measure for the involved modes may be used to derive the weights, where a larger weight is assigned to the smaller cost model.

In one implementation example, a weight for i-th mode may be derived from the sum of the costs of all included models as follows: w_i=(sum−cost_i)/(N−1)/sum, where w_i is the weight of the i_th model and is in the range from 1 to N, sum is the N models' cost sum, cost_i is the cost of the i-th model, N is the number of modes. In one example, the model cost may be the validation cost described above.

In some examples, luma and chroma components may reuse the same model, or luma and chroma may utilize different models. The described above approach for LIC mode may be applied to cross-component intra prediction schemes, for example CCLM, CCCM, cross-component filtering, for example ALF, and other modes where cross-component prediction is used, but the techniques are not limited to any specific type of models and may be used with any model.

For cross-component prediction, a model is derived by using neighbor reconstructed luma and chroma samples, and the validation is done for the reserved luma and chroma neighbor samples of the current block, in one example by applying the model to the luma neighbor samples and calculating the difference between the samples after model application and chroma neighbor samples. In one example, neighbor reconstructed samples may include spatial adjacent, spatial non-adjacent, temporally collocated blocks and others.

Instead of or in addition to motion vector described above, a block vector may be used. For block vectors, it will be intra block copy mode such as IBC or IntraTMP in ECM. The difference from inter prediction is that the current picture is used as a reference, and the techniques may be applied where the current picture is used instead of the reference picture.

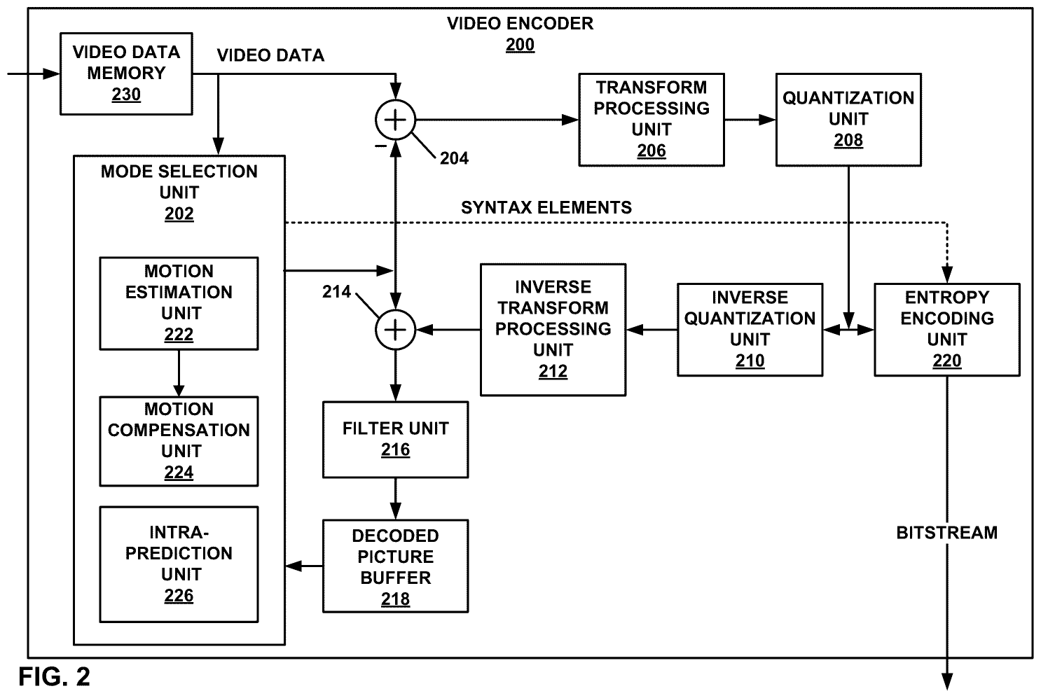

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters.

Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to for each of a plurality of models, determine a respective cost value associated with a corresponding model of the plurality of models to generate respective cost values for the plurality of models, determine a model of the plurality of models to use for encoding a current block of video data based on the respective cost values, and encode the current block based on the determined model.

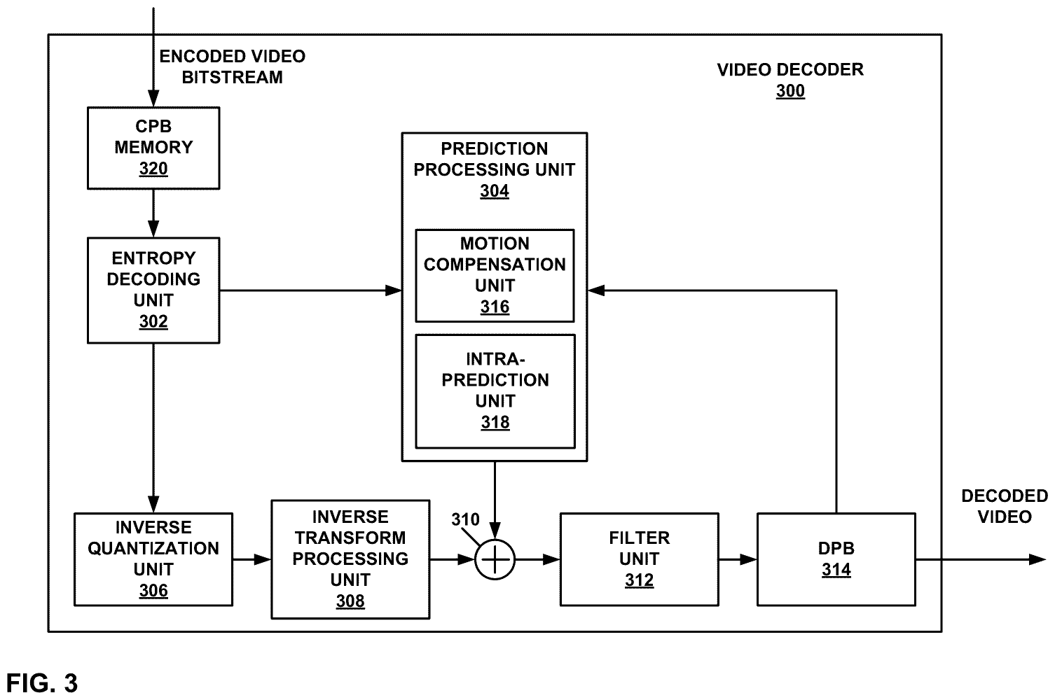

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to for each of a plurality of models, determine a respective cost value associated with a corresponding model of the plurality of models to generate respective cost values for the plurality of models, determining a model of the plurality of models to use for decoding a current block of video data based on the respective cost values, and decode the current block based on the determined model.

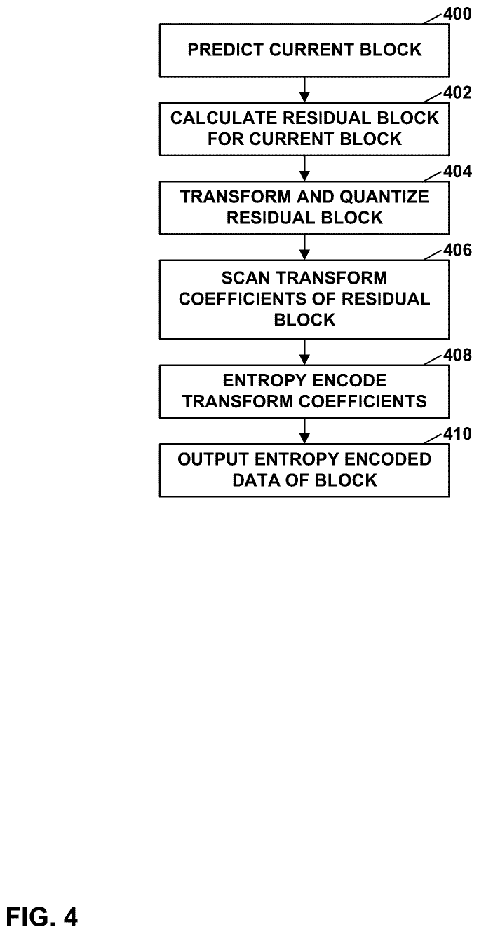

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

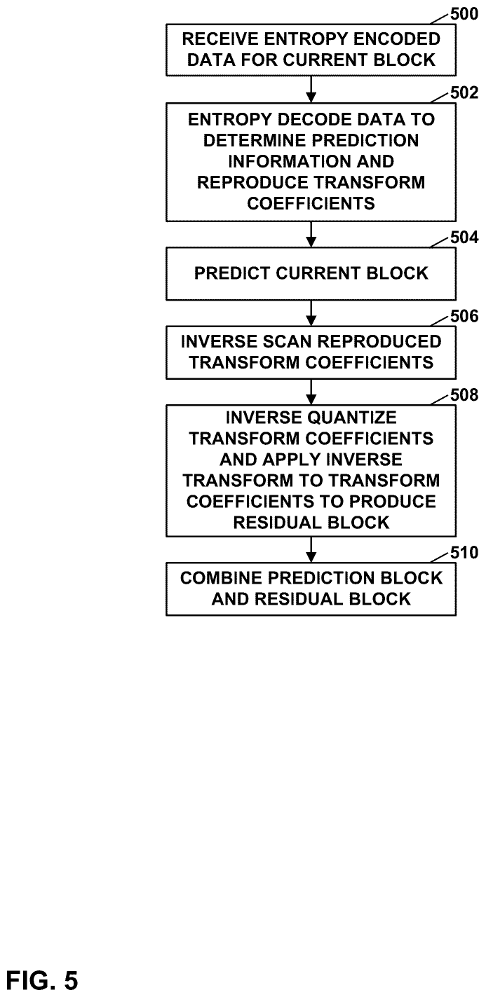

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

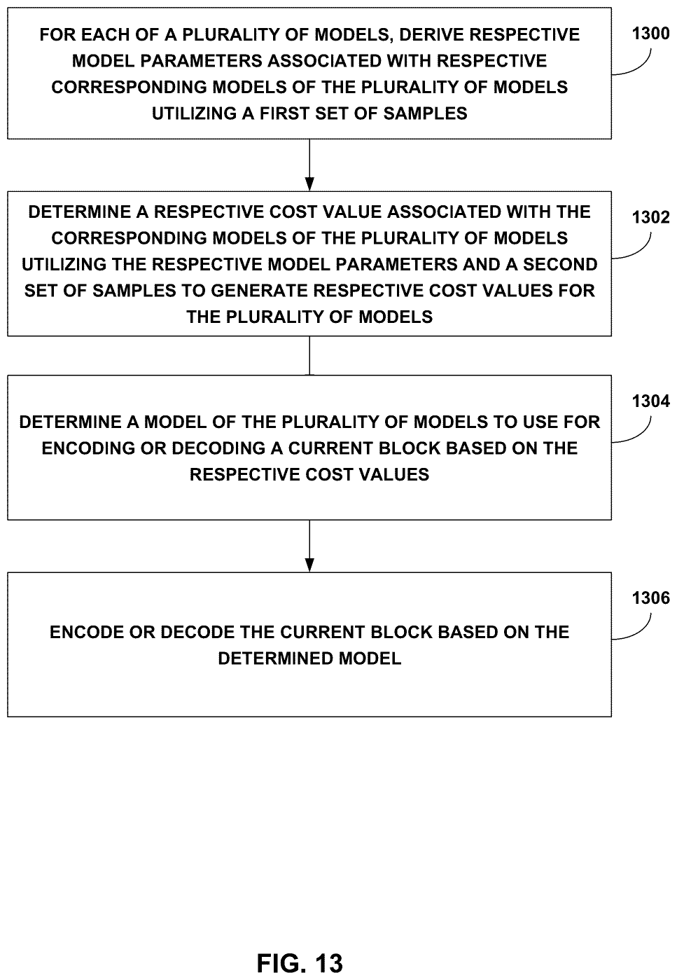

FIG. 13 is a flowchart illustrating an example method in accordance with one or more examples described in this disclosure. The example techniques of FIG. 13 may be performed by processing circuitry of video encoder 200 or video decoder 300. For instance, one or more memories configured to store the video data. Example of the one or more memories include memory 106, memory 120, video data memory 230, decoded picture buffer 218, CPB memory 320, DPB 314, or some other memory of video encoder 200 or video decoder 300. The processing circuitry (e.g., of video encoder 200 or video decoder 300) may be coupled to the one or more memories and configured to perform the example techniques described in this disclosure, such as those of FIG. 13. For ease, reference is also made to FIG. 12.

For each of a plurality of models, the processing circuitry may derive respective model parameters associated with respective corresponding models of the plurality of models utilizing a first set of samples (1300). The plurality of models include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge). In some examples, at least one of the plurality of models is a model used to encode or decode a temporally or spatially neighboring block of the current block.

The model parameters may be nonlinear term P and the bias term B for CCLM. The model parameters may be non-linear terms derived from samples L₀ to L₃ and the offset β for CCCM using non-downsampled luma samples a non luma subsampling. The vertical and horizontal gradients along with the nonlinear term P and the bias term B may be examples of model parameters for GL-CCCM. The above are a few examples of model parameters, and there may be similar other model parameters for different models. The processing circuitry may determine the model parameters, such as the above examples, using the model parameter derivation technique of the respective models, as described above.

The first set of samples may include samples that are not immediately adjacent to the current block. For instance, the first set of samples may be samples 1208 as samples 1208 are not immediately adjacent to the current block 1200, but in the same picture as current block 1200. The first set of samples may include samples that are not immediately adjacent to the current block and samples that are not immediately adjacent to the reference block. For instance, the first set of samples may be samples 1208 and/or samples 1210 as samples 1208 are not immediately adjacent to the current block 1200, but in the same picture as current block 1200, and samples 1210 are not immediately adjacent to the reference block 1202, but in the same picture as reference block 1202. Reference block 1202 is identified by a motion vector for current block 1200.

The processing circuitry may determine a respective cost value associated with the corresponding models of the plurality of models utilizing the respective model parameters and a second set of samples to generate respective cost values for the plurality of models (1302). The first set of samples and the second set of samples may be exclusive of one another. In this way, the processing circuitry may determine model parameters for a model on one set of samples (e.g., the first set of samples), but determine the cost value associated with that model on a different set of samples (e.g., the second set of samples).

For example, the second set of samples may include samples immediately adjacent to the current block, such as samples 1204 in the same picture as current block 1200, where the first set of samples include samples that are not immediately adjacent to the current block 1200 (e.g., samples 1208). As another example, the second set of samples may include samples immediately adjacent to the current block, such as samples 1204 in the same picture as current block 1200, and samples immediately adjacent to a reference block 1202, such as samples 1210 that are in the same picture as reference 1202, where the first set of samples include samples that are not immediately adjacent to the current block 1200, such as samples 1208, and samples that are not immediately adjacent to the reference block 1202, such as samples 1210.

To determine the respective cost values, the processing circuitry may, for each of the plurality of models, generate prediction samples for the second set of samples based on the model parameters. That is, although the second set of samples are available, the processing circuitry may proceed as if the second set of samples are being encoded or decoded. The processing circuitry may determine a difference between the prediction samples and the second set of samples, and determine the cost value associated with the model based on the determined difference.

As an example, the processing circuitry may determine a first prediction signal associated with a first model of the plurality of models based on model parameters of the first model, and determine a first cost value of the respective cost values based on a difference between the first prediction signal and the second set of samples. The processing circuitry may determine a second prediction signal associated with a second model of the plurality of models based on model parameters of the second model, and determine a second cost value of the respective cost values based on a difference between the second prediction signal and the second set of samples.

The processing circuitry may determine a model of the plurality of models to use for encoding or decoding a current block based on the respective cost values (1304). As one example, the processing circuitry may select the model associated with a lowest cost value of the respective cost values. As another example, the processing circuitry may construct a model list of candidates based on the respective cost values, and select the model from the model list of candidates. For example, the processing circuitry may construct a model list of candidates, where the candidates are ordered in the model list based on the respective cost values.

The processing circuitry may encode or decode the current block based on the determined model (1306). For example, the processing circuitry may encode or decode the current block in either of an inter-prediction mode or an intra-prediction mode.

The following numbered clauses illustrate one or more aspects of the devices and techniques described in this disclosure.

Clause 1A. A method of coding video data, the method comprising: for each of a plurality of models, determining a respective cost value associated with a corresponding model of the plurality of models to generate respective cost values for the plurality of models; determining a model of the plurality of models to use for coding a current block of video data based on the respective cost values; and coding the current block based on the determined model.

Clause 2A. The method of clause 1A, wherein determining the model comprises selecting the model associated with a lowest cost value of the respective cost values.

Clause 3A. The method of any of clauses 1A and 2A, further comprising: constructing a model list of candidates based on the respective cost values.

Clause 4A. The method of clause 3A, wherein determining the model comprises receiving an index into the model list.

Clause 5A. The method of any of clauses 3A and 4A, further comprising: constructing an initial model list, wherein constructing the model list comprises at least one of: pruning the initial model list to construct the model list; or determining a valid range of indices in the initial model list, wherein the model list includes the indices, in the valid range, of the initial model list.

Clause 6A. The method of any of clauses 1A-5A, wherein determining the respective costs comprises: for each of the plurality of models, applying the model to samples used to derive the model; determining a difference between samples after model application and target samples; and determining the cost value associated with the model based on the determined difference.

Clause 7A. The method of any of clauses 1A-5A, wherein determining the respective costs comprises: for each of the plurality of models, applying the model to samples not used to derive the model; determining a difference between samples after model application and target samples; and determining the cost value associated with the model based on the determined difference.

Clause 8A. The method of any of clauses 6A and 7A, wherein the target samples comprise samples neighboring the current block.

Clause 9A. The method of any of clauses 1A-8A, wherein determining the respective cost value comprises determining the respective cost value based on samples used for model validation.

Clause 10A. The method of any of clauses 1A-9A, further comprising: associating at least one of the model with the current block or an index into a model list of candidates that identifies the model; storing information indicative of the association; and coding a subsequent block based on the information indicative of the association.

Clause 11A. The method of any of clauses 1A-10A, wherein the model is a first model, the method further comprising: determining a second model to use for coding the current block, wherein coding the current block comprises coding the current block based on the first model and the second model.

Clause 12A. The method of any of clauses 1A-11A, wherein coding comprises decoding.

Clause 13A. The method of any of clauses 1A-12A, wherein coding comprises encoding.

Clause 14A. A device for coding video data, the device comprising: one or more memories configured to store the video data; and one or more processors implemented in circuitry, coupled to the one or more memories, and configured to perform the method of any one or combination of clauses 1A-13A.

Clause 15A. The device of clause 14A, further comprising a display configured to display decoded video data.

Clause 16A. The device of any of clauses 14A and 15A, wherein the device comprises one or more of a camera, a computer, a mobile device, a broadcast receiver device, or a set-top box.

Clause 17A. The device of any of clauses 14A-16A, wherein the device comprises a video decoder.

Clause 18A. The device of any of clauses 14A-17A, wherein the device comprises a video encoder.

Clause 19A. A device for coding video data, the device comprising one or more means for performing the method of any of clauses 1A-13A.

Clause 20A. A computer-readable storage medium having stored thereon instructions that, when executed, cause one or more processors to perform the method of any of clauses 1A-13A.

Clause 1. A method of encoding or decoding video data, the method comprising: for each of a plurality of models, deriving respective model parameters associated with respective corresponding models of the plurality of models utilizing a first set of samples; determining a respective cost value associated with the corresponding models of the plurality of models utilizing the respective model parameters and a second set of samples to generate respective cost values for the plurality of models, wherein the first set of samples and the second set of samples are exclusive of one another; determining a model of the plurality of models to use for encoding or decoding a current block based on the respective cost values; and encoding or decoding the current block based on the determined model.

Clause 2. The method of clause 1, wherein encoding or decoding the current block comprises encoding or decoding the current block in either of an inter-prediction mode or an intra-prediction mode.

Clause 3. The method of any of clauses 1 and 2, wherein the second set of samples include samples immediately adjacent to the current block, and the first set of samples include samples that are not immediately adjacent to the current block.

Clause 4. The method of any of clauses 1-3, wherein the second set of samples include samples immediately adjacent to the current block and samples immediately adjacent to a reference block, and the first set of samples include samples that are not immediately adjacent to the current block and samples that are not immediately adjacent to the reference block.

Clause 5. The method of any of clauses 1-4, wherein determining the respective cost values comprises: for each of the plurality of models, generating prediction samples for the second set of samples based on the model parameters; determining a difference between the prediction samples and the second set of samples; and determining the cost value associated with the model based on the determined difference.

Clause 6. The method of any of clauses 1-5, wherein determining the respective cost values comprises: determining a first prediction signal associated with a first model of the plurality of models based on model parameters of the first model; determining a first cost value of the respective cost values based on a difference between the first prediction signal and the second set of samples; determining a second prediction signal associated with a second model of the plurality of models based on model parameters of the second model; and determining a second cost value of the respective cost values based on a difference between the second prediction signal and the second set of samples.

Clause 7. The method of any of clauses 1-6, wherein the plurality of models include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge).

Clause 8. The method of any of clauses 1-7, wherein determining the model comprises selecting the model associated with a lowest cost value of the respective cost values.

Clause 9. The method of any of clauses 1-8, further comprising: constructing a model list of candidates, wherein the candidates are ordered in the model list based on the respective cost values, wherein determining the model comprises selecting the model from the model list of candidates.

Clause 10. The method of any of clauses 1-9, wherein at least one of the plurality of models is a model used to encode or decode a temporally or spatially neighboring block of the current block.

Clause 11. A device for encoding or decoding video data, the device comprising: one or more memories configured to store the video data; and processing circuitry coupled to the one or more memories, wherein the processing circuitry is configured to: for each of a plurality of models, derive respective model parameters associated with respective corresponding models of the plurality of models utilizing a first set of samples; determine a respective cost value associated with the corresponding models of the plurality of models utilizing the respective model parameters and a second set of samples to generate respective cost values for the plurality of models, wherein the first set of samples and the second set of samples are exclusive of one another; determine a model of the plurality of models to use for encoding or decoding a current block based on the respective cost values; and encode or decode the current block based on the determined model.

Clause 12. The device of clause 11, wherein to encode or decode the current block, the processing circuitry is configured to encode or decode the current block in either of an inter-prediction mode or an intra-prediction mode.

Clause 13. The device of any of clauses 11 and 12, wherein the second set of samples include samples immediately adjacent to the current block, and the first set of samples include samples that are not immediately adjacent to the current block.

Clause 14. The device of any of clauses 11-13, wherein the second set of samples include samples immediately adjacent to the current block and samples immediately adjacent to a reference block, and the first set of samples include samples that are not immediately adjacent to the current block and samples that are not immediately adjacent to the reference block.

Clause 15. The device of any of clauses 11-14, wherein to determine the respective cost values, the processing circuitry is configured to: for each of the plurality of models, generate prediction samples for the second set of samples based on the model parameters; determine a difference between the prediction samples and the second set of samples; and determine the cost value associated with the model based on the determined difference.

Clause 16. The device of any of clauses 11-15, wherein to determine the respective cost values, the processing circuitry is configured to: determine a first prediction signal associated with a first model of the plurality of models based on model parameters of the first model; determine a first cost value of the respective cost values based on a difference between the first prediction signal and the second set of samples; determine a second prediction signal associated with a second model of the plurality of models based on model parameters of the second model; and determine a second cost value of the respective cost values based on a difference between the second prediction signal and the second set of samples.

Clause 17. The device of any of clauses 11-16, wherein the plurality of models include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge).

Clause 18. The device of any of clauses 11-17, wherein to determine the model, the processing circuitry is configured to select the model associated with a lowest cost value of the respective cost values.

Clause 19. The device of any of clauses 11-18, wherein the processing circuitry is configured to: construct a model list of candidates, wherein the candidates are ordered in the model list based on the respective cost values, wherein to determine the model, the processing circuitry is configured to select the model from the model list of candidates.

Clause 20. One or more computer-readable storage media storing instructions thereon that when executed cause one or more processors to: for each of a plurality of models, derive respective model parameters associated with respective corresponding models of the plurality of models utilizing a first set of samples; determine a respective cost value associated with the corresponding models of the plurality of models utilizing the respective model parameters and a second set of samples to generate respective cost values for the plurality of models, wherein the first set of samples and the second set of samples are exclusive of one another; determine a model of the plurality of models to use for encoding or decoding a current block based on the respective cost values; and encode or decode the current block based on the determined model.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding or decoding video data, the method comprising:
for each of a plurality of models, deriving respective model parameters associated with respective corresponding models of the plurality of models utilizing a first set of samples;
determining a respective cost value associated with the corresponding models of the plurality of models utilizing the respective model parameters and a second set of samples to generate respective cost values for the plurality of models, wherein the first set of samples and the second set of samples are exclusive of one another;
determining a model of the plurality of models to use for encoding or decoding a current block based on the respective cost values; and
encoding or decoding the current block based on the determined model.

2. The method of claim 1, wherein encoding or decoding the current block comprises encoding or decoding the current block in either of an inter-prediction mode or an intra-prediction mode.

3. The method of claim 1, wherein the second set of samples include samples immediately adjacent to the current block, and the first set of samples include samples that are not immediately adjacent to the current block.

4. The method of claim 1, wherein the second set of samples include samples immediately adjacent to the current block and samples immediately adjacent to a reference block, and the first set of samples include samples that are not immediately adjacent to the current block and samples that are not immediately adjacent to the reference block.

5. The method of claim 1, wherein determining the respective cost values comprises:
for each of the plurality of models, generating prediction samples for the second set of samples based on the model parameters;
determining a difference between the prediction samples and the second set of samples; and
determining the cost value associated with the model based on the determined difference.

6. The method of claim 1, wherein determining the respective cost values comprises:
determining a first prediction signal associated with a first model of the plurality of models based on model parameters of the first model;
determining a first cost value of the respective cost values based on a difference between the first prediction signal and the second set of samples;
determining a second prediction signal associated with a second model of the plurality of models based on model parameters of the second model; and
determining a second cost value of the respective cost values based on a difference between the second prediction signal and the second set of samples.

7. The method of claim 1, wherein the plurality of models include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge).

8. The method of claim 1, wherein determining the model comprises selecting the model associated with a lowest cost value of the respective cost values.

9. The method of claim 1, further comprising:
constructing a model list of candidates, wherein the candidates are ordered in the model list based on the respective cost values,
wherein determining the model comprises selecting the model from the model list of candidates.

10. The method of claim 1, wherein at least one of the plurality of models is a model used to encode or decode a temporally or spatially neighboring block of the current block.

11. A device for encoding or decoding video data, the device comprising:
one or more memories configured to store the video data; and
processing circuitry coupled to the one or more memories, wherein the processing circuitry is configured to:
for each of a plurality of models, derive respective model parameters associated with respective corresponding models of the plurality of models utilizing a first set of samples;
determine a respective cost value associated with the corresponding models of the plurality of models utilizing the respective model parameters and a second set of samples to generate respective cost values for the plurality of models, wherein the first set of samples and the second set of samples are exclusive of one another;
determine a model of the plurality of models to use for encoding or decoding a current block based on the respective cost values; and
encode or decode the current block based on the determined model.

12. The device of claim 11, wherein to encode or decode the current block, the processing circuitry is configured to encode or decode the current block in either of an inter-prediction mode or an intra-prediction mode.

13. The device of claim 11, wherein the second set of samples include samples immediately adjacent to the current block, and the first set of samples include samples that are not immediately adjacent to the current block.

14. The device of claim 11, wherein the second set of samples include samples immediately adjacent to the current block and samples immediately adjacent to a reference block, and the first set of samples include samples that are not immediately adjacent to the current block and samples that are not immediately adjacent to the reference block.

15. The device of claim 11, wherein to determine the respective cost values, the processing circuitry is configured to:
for each of the plurality of models, generate prediction samples for the second set of samples based on the model parameters;
determine a difference between the prediction samples and the second set of samples; and
determine the cost value associated with the model based on the determined difference.

16. The device of claim 11, wherein to determine the respective cost values, the processing circuitry is configured to:
determine a first prediction signal associated with a first model of the plurality of models based on model parameters of the first model;
determine a first cost value of the respective cost values based on a difference between the first prediction signal and the second set of samples;
determine a second prediction signal associated with a second model of the plurality of models based on model parameters of the second model; and
determine a second cost value of the respective cost values based on a difference between the second prediction signal and the second set of samples.

17. The device of claim 11, wherein the plurality of models include local intensity compensation (LIC), linear model (LM), convolutional cross-component model (CCCM), gradient and location based CCCM (GL-CCCM), cross-component residual model (CCRM), block vector guided CCCM (BVG-CCCM), and cross-component merge (CCMerge).

18. The device of claim 11, wherein to determine the model, the processing circuitry is configured to select the model associated with a lowest cost value of the respective cost values.

19. The device of claim 11, wherein the processing circuitry is configured to:
construct a model list of candidates, wherein the candidates are ordered in the model list based on the respective cost values,
wherein to determine the model, the processing circuitry is configured to select the model from the model list of candidates.

20. One or more computer-readable storage media storing instructions thereon that when executed cause one or more processors to:
for each of a plurality of models, derive respective model parameters associated with respective corresponding models of the plurality of models utilizing a first set of samples;
determine a respective cost value associated with the corresponding models of the plurality of models utilizing the respective model parameters and a second set of samples to generate respective cost values for the plurality of models, wherein the first set of samples and the second set of samples are exclusive of one another;
determine a model of the plurality of models to use for encoding or decoding a current block based on the respective cost values; and
encode or decode the current block based on the determined model.
